(19) United States
(12) Patent Application Publication
(10) Pub. No.: US 2026/0131595 A1
(43) Pub. Date: May 14, 2026

(54) WHEEL MOUNTING STRUCTURE FOR VEHICLE

(71) Applicants: Hyundai Motor Company, Seoul (KR); Kia Corporation, Seoul (KR); Seohan Innobility Co., Ltd., Jincheon-gun (KR)

(72) Inventors: Ju Ho KIM, Hwaseong-Si (KR); Eun Sik Kim, Hwaseong-Si (KR); Hyun Soo Kim, Hwaseong-Si (KR); Young Seung Yu, Hwaseong-Si (KR); Ki Jeong Kim, Hwaseong-Si (KR)

(73) Assignees: Hyundai Motor Company, Seoul (KR); Kia Corporation, Seoul (KR); Seohan Innobility Co., Ltd., Jincheon-gun (KR)

(21) Appl. No.: 19/201,627

(22) Filed: May 7, 2025

(30) Foreign Application Priority Data
Nov. 13, 2024 (KR) 10-2024-0160700

(51) Int. Cl. B60B 3/14; B60B 3/18; B60B 27/00; B60B 27/06; F16B 39/10

(52) U.S. Cl. CPC B60B 3/142; B60B 3/18; B60B 27/0052; B60B 27/065; F16B 39/10

(57) ABSTRACT

A wheel mounting structure for a vehicle includes a wheel hub including a center boss protruding from a hub flange in an axial direction, a wheel fitted around the center boss at an internal diameter portion of the wheel, a center lock bolt threadedly coupled to the center boss and configured to press the wheel against the hub flange, and a locking device configured to lock rotation of the center lock bolt with respect to the wheel hub or to release the locking of rotation of the center lock bolt.

### CROSS-REFERENCE TO RELATED APPLICATION

The present application claims priority to Korean Patent Application No. 10-2024-0160700 filed on Nov. 13, 2024, the entire contents of which is incorporated herein for all purposes by this reference.

### BACKGROUND OF THE PRESENT DISCLOSURE

### Field of the Present Disclosure

The present disclosure relates to technology for mounting a wheel of a vehicle to a wheel hub.

### Description of Related Art

A vehicle is configured to transmit drive force to tires thereof on a road surface, and accordingly, has a structure configured to mount each tire to a wheel and to mount the wheel to the vehicle, to mount the tire to the vehicle.

The wheel is mounted to a wheel hub of the vehicle. For stable power transmission performance and better durability of the vehicle, a firm mounting structure is required between the wheel and the wheel hub.

In conventional cases, a structure configured to fix a wheel to a wheel hub using a plurality of hub bolts and a plurality of wheel nuts is widely used. The present structure provides very strong coupling and high durability.

However, the wheel mounting structure using the plurality of hub bolts and the plurality of wheel nuts has drawbacks in that a relatively long time to replace the wheel is consumed, and the appearance of the wheel mounting structure is somewhat poor.

In keeping with recent increase in popularity of high-performance vehicles and recent advances in motor sports, a further reduced time of replacing the wheel and a more aesthetically pleasing and elegant wheel appearance are required.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a wheel mounting structure for a vehicle which is configured for greatly reducing a wheel replacement time and effectively preventing theft of a wheel while being advantageous in terms of formation of an aesthetically pleasing and elegant wheel appearance.

Objects of the present disclosure are not limited to the above-described object, and other objects of the present disclosure not yet described will be more clearly understood by those skilled in the art from the following detailed description.

In accordance with an aspect of the present disclosure, the above and other objects may be accomplished by the provision of a wheel mounting structure for a vehicle including a wheel hub including a center boss protruding from a hub flange in an axial direction, a wheel fitted around the center boss at an internal diameter portion of the wheel, a center lock bolt threadedly coupled to the center boss and configured to press the wheel against the hub flange, and a locking device configured to lock rotation of the center lock bolt with respect to the wheel hub or to release the locking of rotation of the center lock bolt.

The locking device may be constituted to switch a state of the center lock bolt with respect to the wheel hub between a locking state and a release state through elastic deformation of the center lock bolt generated in accordance with rotation force externally applied thereto through a center portion of the wheel.

The locking device may include a collet bolt provided to receive rotation force through the center portion of the wheel and to rotate by the received rotation force, a collet threadedly coupled to the collet bolt and configured to move in the axial direction in accordance with the rotation of the collet bolt, and a skirt formed at the center lock bolt to be elastically deformable in a radial direction of the center lock bolt in accordance with a movement amount of the collet.

The collet bolt may be provided to extend through a center portion of the center lock bolt.

The collet may be formed to include a conical shape having a diameter gradually increasing in a direction from the center lock bolt toward the wheel hub, and may be provided to be inserted into the skirt.

The skirt may be formed to have, at an internal surface thereof, a shape having a diameter gradually increasing in the direction from the center lock bolt toward the wheel hub.

The skirt may include a plurality of elastic pieces divided from one another in a circumferential direction of the center lock bolt by a plurality of division slots formed lengthily in the axial direction so that the elastic pieces have a uniform width in the circumferential direction of the center lock bolt.

Skirt serrations may be formed at a circumferential surface of an end portion of each elastic piece to form grooves and protrusions in a circumferential direction of each elastic piece.

Hub serrations may be formed at an internal surface of the wheel hub so that the hub serrations are engaged to the skirt serrations of the elastic pieces as a diameter of the skirt increases, for locking rotation of the center lock bolt.

A pressing ring having a wedge-shaped cross-section may be provided at a head flange of the center lock bolt to press the wheel against the hub flange.

A retainer may be integrally formed at the head flange of the center lock bolt to surround an external circumferential surface of the pressing ring.

A circlip may be provided at the retainer to allow relative rotation of the pressing ring while preventing separation of the pressing ring.

The wedge-shaped cross-section of the pressing ring may be formed by an inclined ring surface formed to be inclined with respect to the axial direction to contact with the wheel, an internal circumferential ring surface configured to surround an external circumferential surface of the center boss, and a bolt facing surface formed to be perpendicular to the axial direction so that the bolt facing surface faces the head flange of the center lock bolt.

A friction reducing washer may be located between the bolt facing surface of the pressing ring and the head flange of the center lock bolt to reduce friction therebetween.

A seal ring may be provided at a circumferential surface of the head flange of the center lock bolt to form a seal between the head flange and the wheel.

At least one stud may be provided at the hub flange of the wheel hub so that the stud protrudes to be inserted into a wheel hub groove of the wheel.

The stud may include a stud bolt fastened to the hub flange, and a stud sleeve formed to contact with the wheel hub groove and to allow the stud bolt to extend therethrough. The stud sleeve may be formed of a material different from a material of the stud bolt.

A brake disc may be mounted between the wheel hub and the wheel.

The stud sleeve may have a greater diameter at a portion thereof inserted into the wheel hub groove than at a portion thereof extending through the brake disc, to press the brake disc against the wheel hub by a pressure applied by the stud bolt, fixing the brake disc to the wheel hub.

In accordance with another aspect of the present disclosure, there is provided a wheel hub assembly for a vehicle including a hub flange configured to form a flat surface perpendicular to an axial direction, a center boss protruding from the hub flange in the axial direction, a center lock bolt fastened to the center boss and configured to press, against the hub flange, an internal diameter portion of a wheel fitted around the center boss, and a locking device configured to switch a state of the center lock bolt with respect to the wheel hub between a locking state and a release state through elastic deformation of the center lock bolt generated in accordance with rotation force externally applied thereto through a center portion of the wheel.

The locking device may include a collet bolt provided to extend lengthily in the axial direction through a center portion of the center lock bolt, a collet threadedly coupled to the collet bolt and configured to move in the axial direction in accordance with the rotation of the collet bolt, and a skirt formed at the center lock bolt to be elastically deformable in a radial direction of the center lock bolt in accordance with a movement amount of the collet.

The collet may be formed to include a conical shape having a diameter gradually increasing in a direction from the center lock bolt toward the wheel hub, and may be provided to be inserted into the skirt.

The skirt may be formed to have, at an internal surface thereof, a shape having a diameter gradually increasing in the direction from the center lock bolt toward the wheel hub so that the skirt surface-contacts with the collet.

The skirt may include a plurality of elastic pieces divided from one another in a circumferential direction of the center lock bolt by a plurality of division slots formed lengthily in the axial direction so that the elastic pieces have a uniform width in the circumferential direction of the center lock bolt.

Skirt serrations may be formed at a circumferential surface of an end portion of each elastic piece to form grooves and protrusions in a circumferential direction of each elastic piece.

Hub serrations may be formed at an internal surface of the wheel hub so that the hub serrations are engaged to the skirt serrations of the elastic pieces as a diameter of the skirt increases, for locking rotation of the center lock bolt.

In accordance with another aspect of the present disclosure, there is provided a wheel for a vehicle including an internal diameter portion configured to be fitted around a center boss provided at a rotation center portion of a hub flange, for coupling of the wheel to a wheel hub including the center boss, the wheel hub further including a stud configured to protrude from the hub flange outside the center boss, and a wheel hub groove provided at an area surrounding the internal diameter portion to receive the stud, wherein the area surrounding the internal diameter portion is configured to be pressed against the hub flange by a pressing ring mounted at a center lock bolt threadedly coupled to the center boss, and a pressing state of the area surrounding the internal diameter portion is indirectly locked by rotation of a collet bolt provided to extend through the center lock bolt.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a partially-broken perspective view showing a wheel mounting structure for a vehicle according to an exemplary embodiment of the present disclosure;

FIG. 2 is a sectional view of an essential part of FIG. 1;

FIG. 3 is an exploded perspective view of the essential part of FIG. 1;

FIG. 4 is a detailed sectional view of an essential part of FIG. 2;

FIG. 5 is a sectional view showing a cross-sectional structure of a wheel hub;

FIG. 6 is an exploded perspective view showing a collet, a collet bot, and a center lock bolt; and

FIG. 7 is a view exemplarily illustrating another exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

In the following description of the exemplary embodiments of the present disclosure, a detailed description of known technologies incorporated herein will be omitted when it may obscure the subject matter of the exemplary embodiments of the present disclosure. Furthermore, the exemplary embodiments of the present disclosure will be more clearly understood from the accompanying drawings and should not be limited by the accompanying drawings, and it is to be appreciated that all changes, equivalents, and substitutes that do not depart from the spirit and technical scope of the present disclosure are encompassed in the present disclosure.

It will be understood that, although the terms “first”, “second”, etc. may be used herein to describe various elements, these elements should not be limited by these terms. These terms are only used to distinguish one element from another.

Unless clearly used otherwise, singular expressions include a plural meaning.

In the present specification, the term “comprising”, “including”, or the like, is directed to express the existence of the characteristic, the numeral, the step, the operation, the element, the part, or the combination thereof, and does not exclude another characteristic, numeral, step, operation, element, part, or any combination thereof, or any addition thereto.

Any number of components or a variety of components of any one of the configurations included in the present disclosure may be included in the present disclosure. Such components may include any combination of characterized parts included in the present disclosure, and may be disposed to form any one of various configurations included in the present disclosure. Not only structures and arrangements of the components of the present disclosure, but also concepts as to use and operation thereof, may be applied not only to particular embodiments discussed in the present disclosure, but also to embodiments of any numbers and in any combinations. In the following description, various exemplary embodiments including various characterized parts having various arrangements will be described with reference to the accompanying drawings.

Hereinafter, various embodiments included in the present disclosure will be described in detail with reference to the accompanying drawings, and the same or similar elements are designated by the same reference numerals regardless of the numerals in the drawings and redundant description thereof will be omitted.

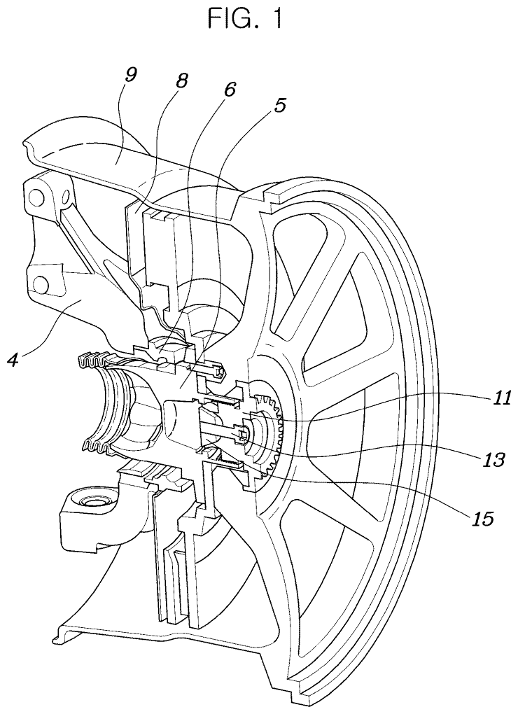

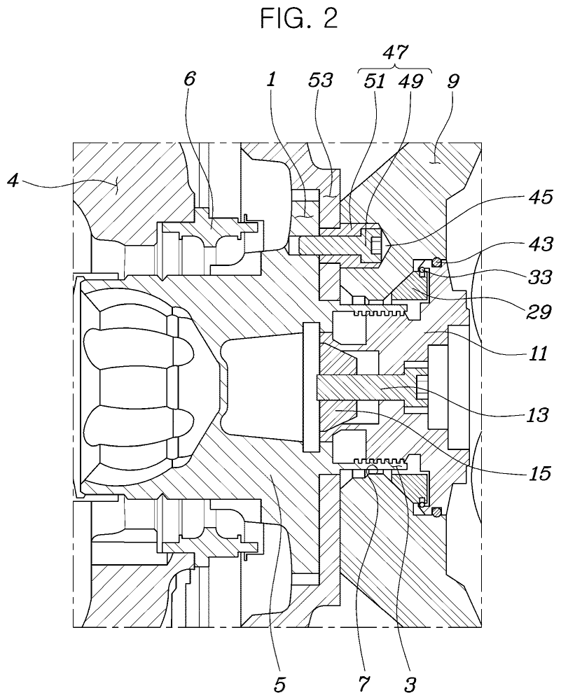

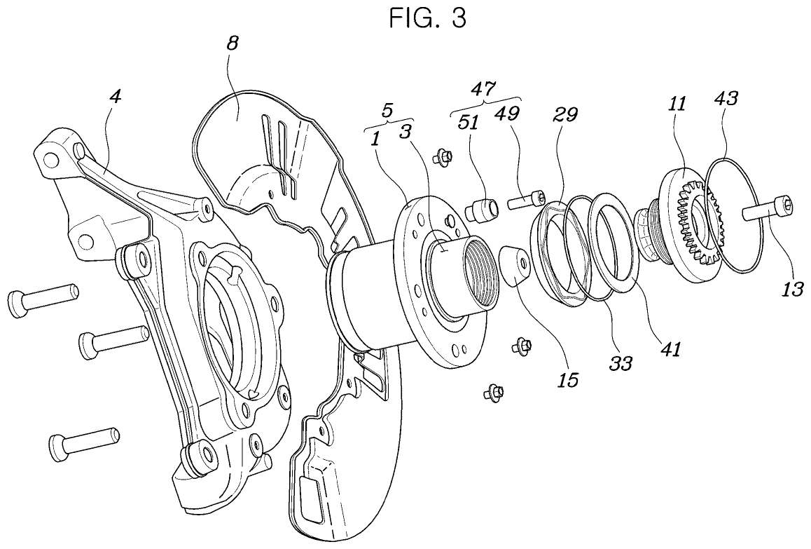

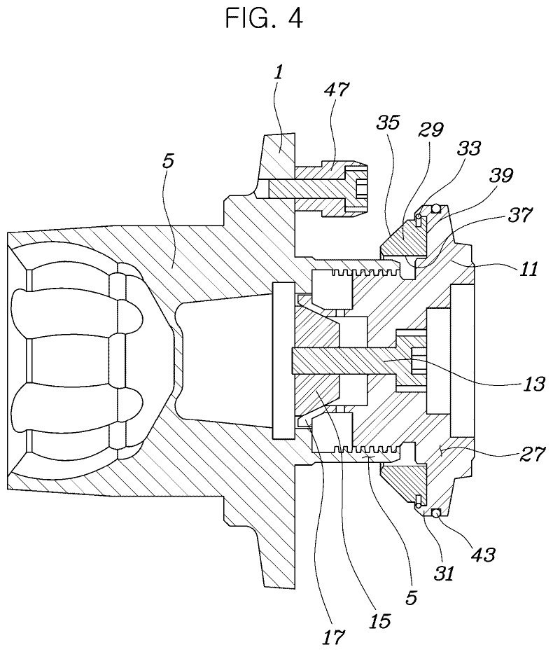

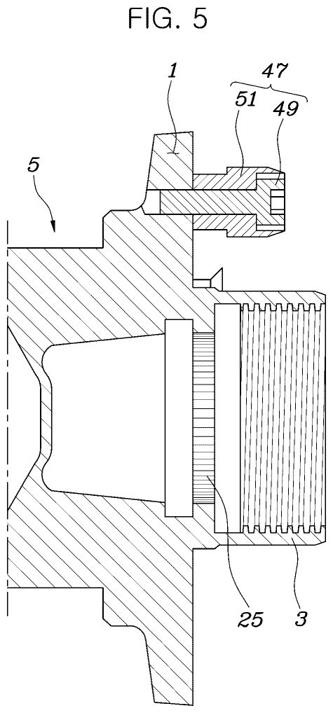

Referring to FIGS. 1 to 6, an exemplary embodiment of a wheel mounting structure for a vehicle in an exemplary embodiment of the present disclosure includes a wheel hub 5 provided with a center boss 3 protruding from a hub flange 1 in an axial direction, a wheel 9 fitted around the center boss 3 at an internal diameter portion 7 thereof, a center lock bolt 11 threadedly coupled to the center boss 3 and configured to press the wheel 9 against the hub flange 1, and a locking device configured to lock rotation of the center lock bolt 11 with respect to the wheel hub 5 or to release the locking of rotation of the center lock bolt 11.

That is, the present disclosure is configured so that the center lock bolt 1 is threadedly coupled to the center boss 3 in a state in which the internal diameter portion 7 of the wheel 9 is fitted around the center boss 3 of the wheel hub 5, establishing a pressing state of the wheel 9 against the hub flange 1, and rotation of the center lock bolt 11 is locked through the locking device, and, accordingly, the pressing state of the wheel 9 is indirectly locked.

For reference, the “axial direction” means a rotation-axial direction of the wheel hub 5.

Meanwhile, referring to FIG. 1, the wheel hub 5 is rotatably supported by a knuckle 4 via a wheel bearing 6. A brake disc 53 is mounted to the wheel hub 5, together with the wheel 9.

In an exemplary embodiment of the present disclosure, a brake disc cover 8 is also shown in FIG. 1. The brake disc cover 8 may be mounted between the knuckle 4 and brake disc 53.

The locking device is configured to switch a state of the center lock bolt 11 with respect to the wheel hub 5 between a locking state and a release state through elastic deformation of the center lock bolt 11 generated in accordance with rotation force externally applied thereto through a center portion of the wheel 9.

In the exemplary embodiment of the present disclosure, the locking device is configured through a collet bolt 13 provided to receive rotation force through the center portion of the wheel 9 and to rotate by the received rotation force, a collet 15 threadedly coupled to the collet bolt 13 and configured to move in the axial direction in accordance with the rotation of the collet bolt 13, and a skirt 17 formed at the center lock bolt 11 to be elastically deformable in a radial direction of the center lock bolt in accordance with a movement amount of the collet 15.

Furthermore, the collet bolt 13 is provided to extend through a center portion of the center lock bolt 11, and the collet 15 is formed to include a conical shape having a diameter gradually increasing in a direction from the center lock bolt 11 toward the wheel hub 5, and is provided to be inserted into the skirt 17.

The skirt 17 is formed to have, at an internal surface thereof, a shape having a diameter gradually increasing in the direction from the center lock bolt 11 toward the wheel hub 5, corresponding to the shape of the collet 15.

Furthermore, the skirt 17 includes a plurality of elastic pieces 21 divided from one another in a circumferential direction of the center lock bolt 11 by a plurality of division slots 19 formed lengthily in the axial direction so that the elastic pieces 21 have a uniform width in the circumferential direction of the center lock bolt 11. Skirt serrations 23 are formed at a circumferential surface of an end portion of each elastic piece 21 to form grooves and protrusions in a circumferential direction of the elastic piece 21.

Corresponding to the skirt serrations 23 of the elastic pieces 21, hub serrations 25 are formed at an internal surface of the wheel hub 5 so that the hub serrations 25 are engaged to the skirt serrations 23 as the diameter of the skirt 17 increases, for locking rotation of the center lock bolt 11.

Accordingly, when the collet bolt 13 rotates in a predetermined direction to move the collet 15 in an axial direction increasing the diameter of the skirt 17, the skirt 17 expands while being elastically deformed. As a result, the skirt serrations 23 come into contact with the hub serrations 25, thereby locking rotation of the center lock bolt 11 with respect to the wheel hub 5. On the other hand, when the collet bolt 13 rotates in a reverse direction opposite to the predetermined direction to move the collet 15 in a direction decreasing the diameter of the skirt 17, the skirt 17 shrinks while being elastically deformed by elastic force of the skirt 17. As a result, the skirt serrations 23 are separated from the hub serrations 25, thereby allowing the center lock bolt 11 to be rotatable with respect to the wheel hub 5.

Thus, in accordance with the present disclosure, it may be possible to complete assembly of the wheel 9 by rotating the collet bolt 13 in the predetermined direction to lock rotation of the center lock bolt 11, after firmly fixing the wheel 9 to the wheel hub 5 by fastening the center lock bolt 11 in a state in which the wheel 9 is fitted around the wheel hub 5. On the other hand, it may be possible to enable separation of the wheel 9 by rotating the collet bolt 13 in the reverse direction to enable rotation of the center lock bolt 11 and then separating the center lock bolt 11 from the center boss 3.

As apparent from the above description, in accordance with the present disclosure, mounting or separation of the wheel 9 to or from the wheel hub 5 may be achieved only through manipulation of the center lock bolt 11 and the collet bolt 13. Accordingly, the time consumed for replacement of the wheel 9 is very short. Furthermore, it may be possible to easily configure the appearance of the wheel 5 to be aesthetically pleasing and elegant because it is unnecessary to fasten additional bolts or nuts.

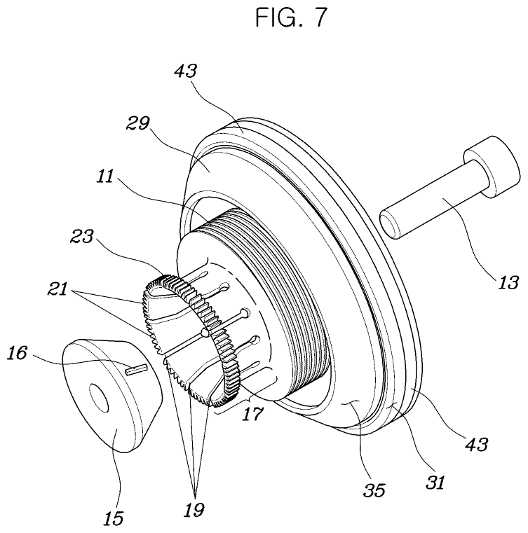

Meanwhile, another exemplary embodiment of the present disclosure is shown in FIG. 7. The configuration of the exemplary embodiment of the present disclosure is identical to that of the exemplary embodiment of FIGS. 1 to 6, except that a collet lug 16 is further provided at the collet 15 to be inserted into one of the division slots 19 of the skirt 17 so that when the collet bolt 13 rotates, the collect lug 16 locks rotation of the collet 15 with respect to the center lock bolt 11.

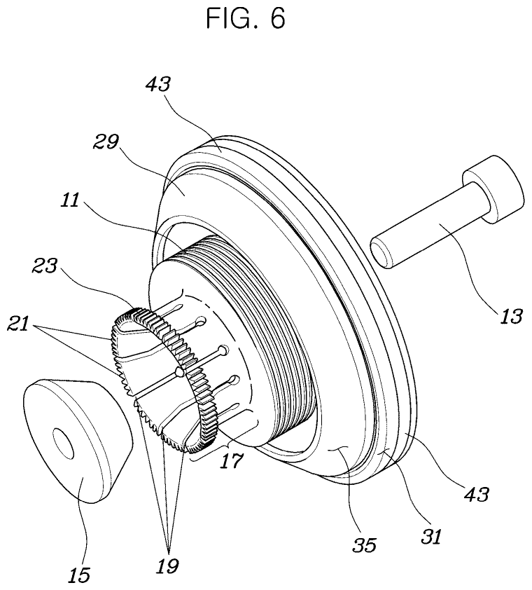

That is, in general, when the collet bolt 13 rotates, rotation of the collet 15 is restricted by frictional contact between the collet 15 and the skirt 19, as shown in FIG. 6. However, in the case in which the collet lug 16 configured to be inserted into one of the division slots 19 is provided as described above in FIG. 7, it may be possible to more reliably prevent rotation of the collet 15 with respect to the center lock bolt 11 during rotation of the collet bolt 13.

Meanwhile, a pressing ring 29 including a wedge-shaped cross-section is provided at a head flange 27 of the center lock bolt 11 to press the wheel 9 against the hub flange 1.

In the exemplary embodiment of the present disclosure, a retainer 31 is integrally formed at the head flange 27 of the center lock bolt 11 to surround an external circumferential surface of the pressing ring 19. A circlip 33 is provided at the retainer 31 to allow relative rotation of the pressing ring 29 while preventing separation of the pressing ring 29 from the center lock bolt 11.

That is, the circlip 33 prevents separation of the pressing ring 29 from the center lock bolt 11, and, accordingly, the pressing ring 29 may be handled by an operator, together with the center lock bolt 11. Accordingly, excellent workability may be secured during replacement of the wheel 9.

The wedge-shaped cross-section of the pressing ring 29 is formed by an inclined ring surface 35 formed to be inclined with respect to the axial direction to contact with the wheel 9, an internal circumferential ring surface configured to surround an external circumferential surface of the center boss 3, and a bolt facing surface 39 formed to be perpendicular to the axial direction so that the bolt facing surface 39 faces the head flange 27 of the center lock bolt 11.

A friction reducing washer 41 is located between the bolt facing surface 39 of the pressing ring 29 and the head flange 27 of the center lock bolt 11 to reduce friction therebetween.

Accordingly, when the center lock bolt 11 is fastened to the center boss 3 so that the pressing ring 29 presses the wheel 9 against the hub flange 1, the inclined ring surface 35 comes into contact with the wheel 9, and the bolt facing surface 39 comes into contact with the friction reducing washer 41. Since relatively great frictional force is generated between the inclined ring surface 35 of the pressing ring 29 and the wheel 9, no relative rotation is generated between the inclined ring surface 35 and the wheel 9 during rotation of the center portion rock bolt 11. On the other hand, since relatively small frictional force is generated between the head flange 27 of the center lock bolt 11 and the bolt facing surface 39 of the pressing ring 29, it may be possible to prevent deformation of the wheel 9 and formation of friction marks at the wheel 9 and to reduce a fastening torque of the center lock bolt 11.

Furthermore, at least one friction reducing groove may be formed at the head flange 27 facing the friction reducing washer 41 to reduce an area of the head flange 27 contacting with the friction reducing washer 41. Accordingly, it may be possible to further reduce frictional force between the head flange 27 and the bolt facing surface 39 of the pressing ring 29.

Meanwhile, a seal ring 43 is provided at a circumferential surface of the head flange 27 of the center lock bolt 11 to form a seal between the head flange 27 and the wheel 9.

That is, when the seal ring 43 is provided between the head flange 27 and the wheel 9, it is possible to prevent foreign matter from penetrating into a space formed between the wheel 9 and the center lock bolt 11 in which the pressing ring 29 is accommodated. Accordingly, the function of a structure configured to generate a frictional force difference between the inclined ring surface 35 and the bolt facing surface 39 of the pressing ring 29 may be stably maintained.

Meanwhile, at least one stud 47 is mounted at the hub flange 1 of the wheel hub 5. The stud 47 protrudes to be inserted into a wheel hub groove 45 of the wheel 9.

Accordingly, relative rotation of the wheel 9 with respect to the wheel hub 5 caused by a torque acting between the wheel 9 and the wheel hub 5 may be structurally prevented. As a result, a firm and stable assembly state between the wheel hub 5 and the wheel 9 may be secured and maintained.

Furthermore, since relative rotation between the wheel hub 5 and the wheel 9 is structurally reliably prevented and the stud 47 neither protrudes from nor is exposed outwardly of the wheel 9 in accordance with insertion of the stud 47 into the wheel hub groove 45, the appearance of the wheel 9 may be greatly enhanced.

The stud 47 may include a stud bolt 49 fastened to the hub flange 1, and a stud sleeve 51 formed to contact with the wheel hub groove 45 and to allow the stud bolt 49 to extend therethrough. The stud sleeve 51 may be formed of a material different from that of the stud bolt 49.

For example, the stud bolt 49 may be made of a steel material, and the stud sleeve 51 may be made of aluminum, an aluminum alloy, or the like.

The stud sleeve 51, which is made of an aluminum alloy, as described above, may provide thermal expansion characteristics similar to those of the wheel 9 made of a material identical or similar to the aluminum alloy, even for a thermal load transmitted thereto from the brake disc 53 in a state in which the stud sleeve 71 is inserted into the wheel 9. Accordingly, a firm and stable assembly state between the wheel 9 and the stud 47 may be maintained.

Meanwhile, the brake disc 53 is mounted between the wheel hub 5 and the wheel 9, and the stud sleeve 51 has a greater diameter at a portion thereof inserted into the wheel hub groove 45 than at a portion thereof extending through the brake disc 53, to press the brake disc 53 against the wheel hub 5 by a pressure applied by the stud bolt 49, fixing the brake disc 53 to the wheel hub 5.

Accordingly, even when the wheel 9 is in a state of being separated from the wheel hub 5 in accordance with removal of the center lock bolt 11 from the center boss 3, the state of the brake disc 53 fixed to the wheel hub 5 may be stably maintained by the stud sleeve 51.

Meanwhile, a wheel hub assembly used in the above-described wheel mounting structure for a vehicle according to an exemplary embodiment of the present disclosure includes a hub flange 1 configured to form a flat surface perpendicular to an axial direction, a center boss 3 protruding from the hub flange 1 in the axial direction, a center lock bolt 11 fastened to the center boss 3 and configured to press, against the hub flange 1, an internal diameter portion 7 of a wheel 9 fitted around the center boss 3, and a locking device configured to switch a state of the center lock bolt 11 with respect to the wheel hub 5 between a locking state and a release state through elastic deformation of the center lock bolt 11 generated in accordance with rotation force externally applied thereto through a center portion of the wheel 9.

The locking device includes a collet bolt 13 provided to extend lengthily in the axial direction through a center portion of the center lock bolt 11, a collet 15 threadedly coupled to the collet bolt 13 and configured to move in the axial direction in accordance with the rotation of the collet bolt 13, and a skirt 17 formed at the center lock bolt 11 to be elastically deformable in a radial direction of the center lock bolt in accordance with a movement amount of the collet 15.

The collet 15 is formed to include a conical shape having a diameter gradually increasing in a direction from the center lock bolt 11 toward the wheel hub 5, and is provided to be inserted into the skirt 17. The skirt 17 is formed to have, at an internal surface thereof, a shape having a diameter gradually increasing in the direction from the center lock bolt 11 toward the wheel hub 5 so that the skirt 17 surface-contacts with the collet 15.

The skirt 17 includes a plurality of elastic pieces 21 divided from one another in a circumferential direction of the center lock bolt 11 by a plurality of division slots 19 formed lengthily in the axial direction so that the elastic pieces 21 have a uniform width. Skirt serrations 23 are formed at a circumferential surface of an end portion of each elastic piece 21 to form grooves and protrusions in a circumferential direction of the elastic piece 21. Hub serrations 25 are formed at an internal surface of the wheel hub 5 so that the hub serrations 25 are engaged to the skirt serrations 23 of the elastic pieces 21 as the diameter of the skirt 17 increases, locking rotation of the center lock bolt 11.

Meanwhile, a wheel for a vehicle used in the above-described wheel mounting structure for a vehicle according to an exemplary embodiment of the present disclosure includes an internal diameter portion 7 configured to be fitted around a center boss 3 provided at a rotation center portion of a hub flange 1, for coupling of the wheel to a wheel hub 5 including the center boss 3, the wheel hub 5 further including a stud 47 configured to protrude from the hub flange 1 outside the center boss 3. The wheel further includes a wheel hub groove 45 provided at an area surrounding the internal diameter portion 7 to receive the stud 47. The area surrounding the internal diameter portion 7 is configured to be pressed against the hub flange 1 by a pressing ring 29 provided at a center lock bolt 11 threadedly coupled to the center boss 3. The pressing state of the area surrounding the internal diameter portion 7 is indirectly locked by rotation of a collet bolt 13 provided to extend through the center lock bolt 11.

As apparent from the above description, the present disclosure provides a wheel mounting structure for a vehicle which is configured for greatly reducing a wheel replacement time and effectively preventing theft of a wheel while being advantageous in terms of formation of an aesthetically pleasing and elegant wheel appearance.

Effects attainable in an exemplary embodiment of the present disclosure are not limited to the above-described effects, and other effects of the present disclosure not yet described will be more clearly understood by those skilled in the art from the above-described detailed description.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “or” used in an exemplary embodiment of the present disclosure should be interpreted as indicating “additionally or alternatively.”

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

The terms used to describe the exemplary embodiments are used for describing predetermined embodiments, and are not intended to limit the embodiments. As used in the description of the exemplary embodiments and in the claims, the singular forms “a”, “an”, and “the” include plural referents unless the context clearly dictates otherwise. The expression “and/or” is used to include all possible combinations of terms.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

As used herein, conditional expressions such as “if” and “when” are not limited to an optional case and are intended to be interpreted, when a specific condition is satisfied, to perform the related operation or interpret the related definition according to the specific condition.

Terms such as first and second may be used to describe various elements of the embodiments. However, various components according to the exemplary embodiments should not be limited by the above terms. These terms are only used to distinguish one element from another.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A wheel mounting structure for a vehicle, the wheel mounting structure comprising:
a wheel hub including a hub flange and a center boss protruding from the hub flange in an axial direction of the wheel hub;
a wheel fitted around the center boss at an internal diameter portion of the wheel;
a center lock bolt threadedly coupled to the center boss and configured to press the wheel against the hub flange; and
a locking device configured to lock rotation of the center lock bolt with respect to the wheel hub or to release the locking of rotation of the center lock bolt.

2. The wheel mounting structure of claim 1, wherein the locking device is configured to switch a state of the center lock bolt with respect to the wheel hub between a locking state and a release state through elastic deformation of the center lock bolt generated in accordance with rotation force externally applied thereto through a center portion of the wheel.

3. The wheel mounting structure of claim 2, wherein the locking device includes:
a collet bolt provided to receive the rotation force through the center portion of the wheel and to rotate by the received rotation force;
a collet threadedly coupled to the collet bolt and configured to move in the axial direction in accordance with the rotation of the collet bolt; and
a skirt formed at the center lock bolt to be elastically deformable in a radial direction of the center lock bolt in accordance with a movement amount of the collet.

4. The wheel mounting structure of claim 3,
wherein the collet bolt is mounted to extend through a center portion of the center lock bolt; and
wherein the collet is formed to include a conical shape having a diameter increasing in a direction from the center lock bolt toward the wheel hub, and is provided to be inserted into the skirt.

5. The wheel mounting structure of claim 4, wherein the skirt is formed to have, at an internal surface thereof, a shape having a diameter increasing in the direction from the center lock bolt toward the wheel hub.

6. The wheel mounting structure of claim 3,
wherein the skirt includes a plurality of elastic pieces divided from one another in a circumferential direction of the center lock bolt by a plurality of division slots formed lengthily in the axial direction so that the elastic pieces have a uniform width in the circumferential direction of the center lock bolt;
wherein skirt serrations are formed at a circumferential surface of an end portion of each elastic piece to form grooves and protrusions in a circumferential direction of each elastic piece; and
wherein hub serrations are formed at an internal surface of the wheel hub so that the hub serrations are engaged to the skirt serrations of the elastic pieces as a diameter of the skirt increases, for locking the rotation of the center lock bolt.

7. The wheel mounting structure of claim 6, wherein a collet lug is formed at the collet to be inserted into one of the division slots of the skirt so that based on that the collet bolt rotates, the collect lug locks rotation of the collet with respect to the center lock bolt.

8. The wheel mounting structure of claim 6, wherein, based on that the collet bolt rotates in a first direction, the collet elastically deforms the skirt in a direction increasing the diameter of the skirt while linearly moving in the axial direction toward the wheel, causing the skirt to expand while being elastically deformed so that the skirt serrations come into contact with the hub serrations, for locking the rotation of the center lock bolt with respect to the wheel hub.

9. The wheel mounting structure of claim 8, wherein, based on that the collet bolt rotates in a second direction, the collet moves linearly in the axial direction toward the wheel hub, causing the skirt to be elastically recovered in a direction decreasing the diameter thereof so that the skirt serrations are separated from the hub serrations, for allowing the center lock bolt to be rotatable with respect to the wheel hub.

10. The wheel mounting structure of claim 1, further including a pressing ring having a wedge-shaped cross-section and mounted at a head flange of the center lock bolt to press the wheel against the hub flange.

11. The wheel mounting structure of claim 10, further including:
a retainer integrally formed at the head flange of the center lock bolt and surrounding an external circumferential surface of the pressing ring; and
a circlip mounted at the retainer to allow relative rotation of the pressing ring while preventing separation of the pressing ring.

12. The wheel mounting structure of claim 11, wherein the wedge-shaped cross-section of the pressing ring includes:
an inclined ring surface formed to be inclined with respect to the axial direction to contact with the wheel;
an internal circumferential ring surface configured to surround an external circumferential surface of the center boss; and
a bolt facing surface formed to be perpendicular to the axial direction so that the bolt facing surface faces the head flange of the center lock bolt.

13. The wheel mounting structure of claim 12, further including a friction reducing washer located between the bolt facing surface of the pressing ring and the head flange of the center lock bolt to reduce friction therebetween.

14. The wheel mounting structure of claim 10, further including a seal ring mounted at a circumferential surface of the head flange of the center lock bolt to form a seal between the head flange and the wheel.

15. The wheel mounting structure of claim 1, further including:
at least one stud mounted at the hub flange of the wheel hub so that the at least one stud protrudes to be inserted into a wheel hub groove of the wheel,
wherein the at least one stud includes:
a stud bolt fastened to the hub flange; and
a stud sleeve formed to contact with the wheel hub groove and to allow the stud bolt to extend therethrough, the stud sleeve being formed of a material different from a material of the stud bolt; and
a brake disc mounted between the wheel hub and the wheel,
wherein the stud sleeve has a greater diameter at a portion thereof inserted into the wheel hub groove than at a portion thereof extending through the brake disc, to press the brake disc against the wheel hub by a pressure applied by the stud bolt, for fixing the brake disc to the wheel hub.

16. A wheel hub assembly for a vehicle, the wheel hub assembly comprising:
a hub flange including a flat surface perpendicular to an axial direction;
a center boss protruding from the hub flange in the axial direction;
a center lock bolt fastened to the center boss and configured to press, against the hub flange, an internal diameter portion of a wheel fitted around the center boss; and
a locking device configured to switch a state of the center lock bolt with respect to a wheel hub between a locking state and a release state through elastic deformation of the center lock bolt generated in accordance with rotation force externally applied thereto through a center portion of the wheel.

17. The wheel hub assembly of claim 16, wherein the locking device includes:
a collet bolt provided to extend lengthily in the axial direction through a center portion of the center lock bolt;
a collet threadedly coupled to the collet bolt and configured to move in the axial direction in accordance with rotation of the collet bolt; and
a skirt formed at the center lock bolt to be elastically deformable in a radial direction of the center lock bolt in accordance with a movement amount of the collet.

18. The wheel hub assembly of claim 17,
wherein the collet is formed to have a conical shape having a diameter increasing in a direction from the center lock bolt toward the wheel hub, and is provided to be inserted into the skirt, and
wherein the skirt is formed to have, at an internal surface thereof, a shape having a diameter increasing in the direction from the center lock bolt toward the wheel hub so that the skirt surface-contacts with the collet.

19. The wheel hub assembly of claim 18,
wherein the skirt includes a plurality of elastic pieces divided from one another in a circumferential direction of the center lock bolt by a plurality of division slots formed lengthily in the axial direction so that the elastic pieces have a uniform width in the circumferential direction of the center lock bolt,
wherein skirt serrations are formed at a circumferential surface of an end portion of each elastic piece to form grooves and protrusions in a circumferential direction of each elastic piece, and
wherein hub serrations are formed at an internal surface of the wheel hub so that the hub serrations are engaged to the skirt serrations of the elastic pieces as a diameter of the skirt increases, for locking rotation of the center lock bolt.

20. A wheel for a vehicle, the wheel comprising:
an internal diameter portion configured to be fitted around a center boss provided at a rotation center portion of a hub flange, to couple the wheel to a wheel hub including the center boss, the wheel hub further including a stud configured to protrude from the hub flange outside the center boss;
a wheel hub groove provided at an area surrounding the internal diameter portion to receive the stud;
a center lock bolt threadedly coupled to the center boss; and
a pressing ring mounted at the center lock bolt threadedly coupled to the center boss,
wherein the area surrounding the internal diameter portion is configured to be pressed against the hub flange by the pressing ring mounted at the center lock bolt threadedly coupled to the center boss, and a pressing state of the area surrounding the internal diameter portion is indirectly locked by rotation of a collet bolt provided to extend through the center lock bolt.
